(19) United States
(12) Patent Application Publication
(10) Pub. No.: US 2023/0117081 A1
(43) Pub. Date: Apr. 20, 2023

(54) PROVIDING A USER-CENTRIC APPLICATION

(71) Applicant: Hewlett-Packard Development Company, L.P., Spring, TX (US)

(72) Inventors: Andrew Arthur Hunter, Bristol (GB); M Anthony Lewis, Palo Alto, CA (US); Madhu Sudan Athreya, Palo Alto, CA (US); Sheryl Anne Morgan, Palo Alto, CA (US); Shane Dee Wall, Boise, ID (US)

(73) Assignee: Hewlett-Packard Development Company, L.P., Spring, TX (US)

(21) Appl. No.: 17/766,404

(22) PCT Filed: Oct. 31, 2019
(86) PCT No.: PCT/US2019/059091

§ 371 Date: Apr. 4, 2022

(51) Int. Cl. G06F 9/50; H04L 67/10

(52) U.S. Cl. CPC G06F 9/5072; H04L 67/10; G06F 2209/503

(57) ABSTRACT

According to aspects of the present disclosure there are provided methods and apparatus for providing a user-centric application comprising a plurality of service modules, the method comprising identifying available resources associated with each of a plurality of edge devices in the local network, identifying a first device of the local network, the first device offering a user input service, identifying a second device of the local network, the second device to receive an output event and present the output event for consumption by the user, for each service module, each service module to provide a portion of a functionality of the user-centric application and having an associated resource request, deploying the service module to an edge device based on the associated resource request and the identified available resources, and configuring data flows between the deployed service modules, the first device, and the second device to realize the user-centric application.

### BACKGROUND

Personal computing devices such as desktop PCs, laptops, tablets and phones are familiar devices for user-centric computing. They combine mechanisms for user input, user output and for executing application software. Common applications of PCs include email, word processing, photo viewing/editing, web-browsing, viewing digital TV, slide presenting/editing, video or audio conferencing, computer-aided design, PC gaming and viewing/editing social media. These PC applications mostly involve data content that is generated or curated by human users and is consumed by human users on their PCs.

Internet of Things, IoT, devices are becoming a common presence in homes and in public and business premises. IoT devices typically capture data and send it to be processed in a central cloud data center. Common applications of data-centric computing include home security, factory automation, healthcare monitoring, building operation, retail and inventory operations, logistics, and smart city applications. For example, data might be captured in a factory and be sent to a central data center to monitor the efficient operation of the factory and/or to detect failure conditions. Mostly, the data is generated/captured and consumed by machines.

### BRIEF INTRODUCTION OF THE DRAWINGS

Various features of the present disclosure will be apparent from the detailed description which follows, taken in conjunction with the accompanying drawings, which together illustrate features of the present disclosure, and wherein:

FIG. 1 illustrates a system to provide a user-centric application according to examples of the disclosure;

FIG. 2 illustrates an arrangement of edge devices and IoT devices in the system of FIG. 1 according to examples of the disclosure;

FIG. 3 illustrates a further arrangement of edge devices and IoT devices in the system of FIG. 1 according to examples of the disclosure;

FIG. 4 illustrates an application according to examples of the disclosure;

FIG. 5 shows a method according to examples of the disclosure; and

FIG. 6 is a schematic block diagram of a computer system according examples of the disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

While the abilities and applications provided by personal computing devices remain important to many users there is a cost associated with owning and maintaining such devices. For less frequent users of the applications, PC costs may be prohibitive.

Many commonly used applications, such as office applications, email, image processing, etc. have been made available as web applications executing on cloud servers and allowing use of these applications via any device able to provide access to the cloud through a web browser application. However, use of cloud applications for certain use cases, for example video processing, may be complicated due to costs and bandwidth limitations of data transmission to central cloud data centers. Communication with the cloud servers may introduce latencies that are unacceptable for certain use cases. Furthermore, privacy concerns associated with storing personal data and documents on cloud servers operated by large internet companies are becoming increasingly important to many users.

Similarly, in the IoT realm, transmission of data captured by IoT devices may raise cost, bandwidth and privacy concerns. To address this, computing systems may capture and analyse data before, or instead, of transmitting it to cloud data centers. These computing systems include edge, mist or fog computing systems, but will be referenced herein as data-centric computing systems. The data-centric computing systems may be designed as clusters of edge computation devices and edge sensors and actuators.

IoT devices may include Smart TVs, smart speakers, etc. A Smart TVs may allow apps to be installed and run on the processing resources of the Smart TV. A user may interact with the installed applications using wired or wireless I/O peripherals, such as a Bluetooth keyboard or infra-red remote control, connected to the Smart TV. Furthermore, the Smart TVs may offer web browsers able to access cloud applications.

A smart speaker may not be able to execute arbitrary applications at the user’s location. However, various skills can be enabled that might overlap with certain user-centric applications, such as weather reporting or simple games. However, these skills are provided by software executing in central cloud servers and may therefore suffer from the latency, bandwidth and privacy issues discussed above.

An edge computing platform for data-centric applications may provide a framework for application software to be deployed to edge nodes and thereby allows functions that consume IoT sensor data to be executed locally while relying on cloud services for management, analytics and storage. This allows for decisions on IoT sensor data to be made locally to the IoT devices with low latencies before uploading results to the cloud. However, the platform may rely heavily on the cloud, for example to define the devices on which the functions will run and the data flows between them. The platform may not be suitable for user-centric applications where the available devices depend on the variable environments of individual users rather than on a cloud-based definition.

Certain examples described herein provide methods and devices that allow combining of IoT components for human-centric input and output, with platform technologies designed for data-centric applications to emulate the local functionality of applications running on a PC. A user-centric application may be provided as a plurality of service-oriented application modules that configure data flows and perform local computation where necessary to provide the user with PC-like functionality. In a user-centric application, the function of the application is controlled substantially by a user acting on an input mechanism and responding to an output mechanism, such as when a user responds to the state of a game to control the course of the game and its outcomes. Thus, a user-centric application is able to provide a particular functionality to a user based on user interactions with the application. This contrasts with the data-centric applications in edge computing platforms, discussed above, in which data may be generated, processed and uploaded without any user interaction.

According to the described methods, a software application is deployed to a data-centric cluster. The application includes a set of service modules and service descriptors. The service modules can be deployed to a plurality of execution services on the computing devices in the cluster (according to execution requirements in the descriptors and local availability at the point of execution). By adding further computing devices to the cluster, the user or owner of the environment can scale the computation resources available to the applications deployed there.

The deployed service modules can make requests of each other and requests of other services already deployed in the cluster, such as user interface services provided by IoT devices. For example, a video camera in the cluster might offer a video stream service, and a smart TV might offer a video display service. If more than one service is available to satisfy a service request in accordance with the requirements of the service descriptor, service bindings can be established according to various strategies including minimum latencies, maximum bandwidths or historic preferences for a user/environment or learnt patterns of use.

By configuring data flows between the deployed application service modules and the user interface services provided by IoT devices in the network, the behaviour of a traditional user-centric application executing on a personal computing device can be replicated. The user-centric application may be one from a set including but not limited to: email, word processing, photo viewing/editing, web-browsing, viewing digital TV, slide presenting/editing, video or audio conferencing, computer-aided design, PC gaming and viewing/editing social media.

A personal computing device, for example a laptop, includes a set of input sensors, such as a keyboard, trackpad and microphone; a set of output actuators, such as a display and speakers; processing resources; and a network interface. The processing resources can be used to execute application software to display a graphical user interface on the display and generate sounds through the speakers. A user is able to interact with the user interface via the input sensor, e.g. by typing text on the keyboard or directing a cursor using the trackpad. The executed application can also exchange data with application and data services running in a public cloud via the network interface and the public internet.

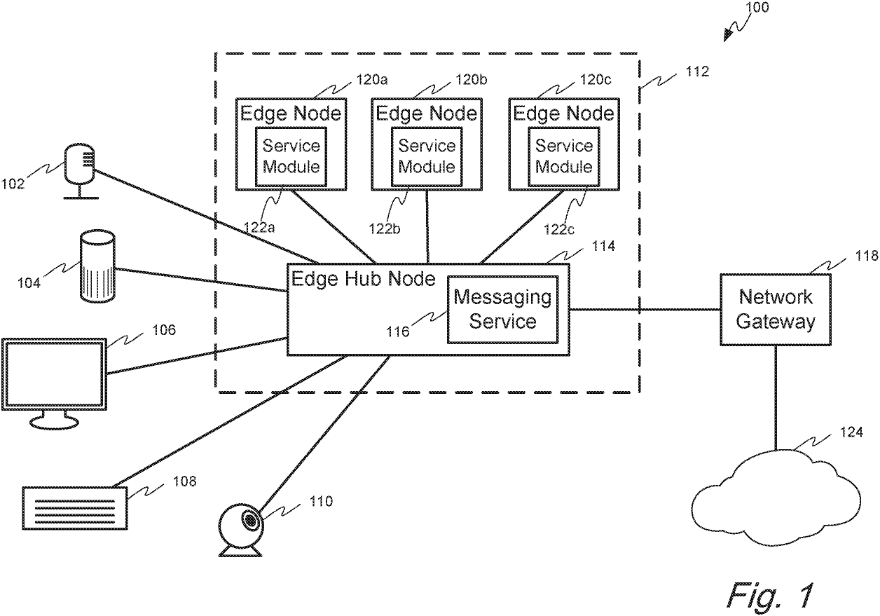

FIG. 1 illustrates a system 100 able to provide a user with an experience equivalent to that provided by a personal computing device according to an example of the disclosure. In the example, shown in FIG. 1, an edge cluster 112 comprises a plurality of edge compute nodes 120a, 120b, 120c and an edge hub node 114 communicatively coupled via a network. While edge hub node 114 is illustrated as distinct from edge compute nodes 120a-120c, in some examples the hub node functionality may be provided by any one of edge compute nodes 120a-120c. Alternatively, in some examples, the functionality associated with hub node 114 may be distributed across multiple, or all, compute nodes in the edge compute cluster 112. Edge hub node 114 includes a messaging service 116 to facilitate communication between the edge nodes and other devices in the network.

The system of FIG. 1 further includes a number of user interface devices, such as IoT devices. Example IoT devices illustrated in FIG. 1 include microphone 102, smart speaker 104, Smart TV or display 106, keyboard 108, and IP camera 110. The described methods and techniques are not limited to these examples, but rather the IoT devices may include any device providing a user interface service, such as a user input interface or output rendering service could be used.

Edge hub node 114 is further coupled to a network gateway 118 that provides communication with cloud services 124, for example via the Internet.

An application to provide the user-centric application functionality can be deployed as a collection of microservices, or application service modules 122a, 122b, 122c on one or more of the edge compute nodes 120a, 120b, 120c.

In some examples, an application to provide the user-centric application functionality, and comprising a collection of application service modules 122a, 122b, 122c can be downloaded into the edge cluster 112 from the cloud service 124 via network gateway 118. Downloading of the application may be in response to a request made by a user via one of the IoT devices, such as a request to launch a user-centric application on a Smart TV 106. Additionally, the application may be pushed to the edge cluster 112 by the cloud service 124, for example based on expected usage patterns of the user, such as a scheduled call, or a request made via a cloud service for the application to be run.

In operation, user input events may be published by the IoT devices using messaging service 116. A microservice, e.g. service module 120a, may subscribe to relevant input events published to the messaging service 116. For example, a service module may subscribe to “keystroke” events published by IoT keyboard 108, or touch events published by a touch screen display, etc. A first service module 120a may consume these events and generate further IoT events to provide feedback to the user, e.g. display events to be presented on Smart TV 106.

As with a personal computer, a user can operate a user interface displayed on the display 106 using a PC-like human-machine-interface paradigm provided by IoT input sensors, e.g. by typing text on the keyboard 108 and by pointing and clicking on elements on the visual display using a pointing device such as a mouse. Application service modules 122a-c can exchange data between themselves, such that each service module may provide a portion of the functionality of the application. Furthermore, if desired the application service modules may exchange data with application and data services running in the cloud service 124 via network gateway 118.

Thus, in environments that are increasingly populated with IoT and data-centric edge computing devices from multiple vendors, examples of the disclosure allow deployment of user-centric personal computing applications as if on a general-purpose personal computer, even when there is no such personal computer in the environment.

For example, in a home environment, a user might have an IoT camera connected to an IoT computing device that performs video data analysis locally before uploading the results to a security service in the cloud. In the same environment, a user might also have a smart speaker 104 connected to a voice-operated music service, and a Smart TV 106.

Thus, as an example of use cases enabled by the above described techniques, when a user might run a video conferencing application on a personal computing device such as a PC or a phone, the user has an alternative option of running a virtual video conferencing application, as a collection of interconnected service modules deployed on the cluster of devices that constitute the IoT infrastructure. In this case, data flows would be configured between the IoT camera, smart speaker 104, microphone 102, and the Smart TV 106 to capture local audio/video and to display remote audio/video with the processing performed on the edge compute nodes 120a-c.

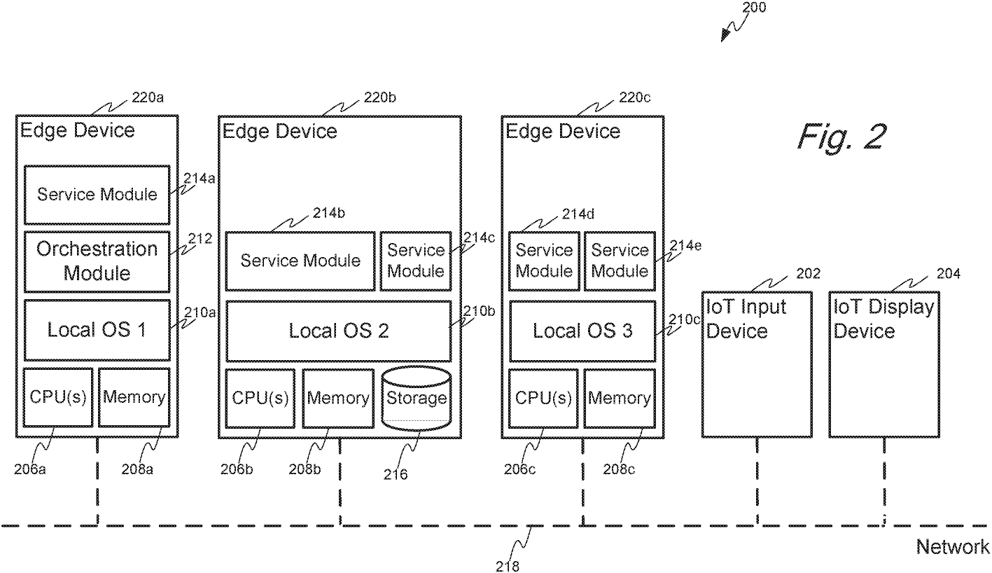

FIG. 2 illustrates a schematic representation of edge devices and IoT devices in the system 100 of FIG. 1 according to an example of the disclosure. In the system 200 illustrated in FIG. 2, there is provided an IoT input device 202, IoT output device 204, and a number of edge compute nodes, or devices, 220a-c. Edge compute nodes and edge compute devices are examples of edge devices 220a-c. The IoT devices and edge compute nodes 220a-c are communicatively coupled via a network 218. Each edge compute node comprises certain processing resources 206a-c and memory, e.g. RAM, 208a-c. An operating system 210a-c is provided to manage software executing on the edge compute node and manage local hardware functions. Edge compute devices 220a-c may provide similar resources and a common operating system, i.e. provide a homogeneous group of devices, or may be a heterogeneous group of devices.

Examples of IoT input device 202 may include, a keyboard 108, a pointing device such as a mouse, track pad or touchscreen, a microphone 102, and an IP camera 110. Examples of IoT output device 204 may include a display such as a Smart TV 106, and a smart speaker 104.

In the system 200 illustrated in FIG. 2, edge compute device 220b includes persistent storage 216 that is not present in the other edge device. In some examples, certain edge compute devices may be provided with other capabilities that are not universally provided. For example, an edge compute device may be provided with graphics accelerator hardware, i.e. a GPU; a digital signal processor; or a neural network accelerator.

First edge compute device 220a further includes orchestration module 212. Orchestration module 212 may be provided as software instructions stored in a memory 208a of the first edge compute device 220a and executed on using the processing resources 206a of the first edge compute node 220a. The orchestration module manages deployment of service modules to edge compute devices 220a-c in the system 200. In operation, orchestration module communicates with the devices in the system 200 to identify available resources such as processing, storage, hardware accelerator availability, etc. and also human interface services offered by IoT devices in the network. In particular, the orchestration module 212 identifies the available resources associated with each of the plurality of edge compute devices 220a-c in the local network 218, identifies a user input service associated with the IoT input device 202, and identifies an output event that can be rendered by the IoT output device 204. Identification of the available resources in the local network may be performed by the orchestration module 212 continually monitoring the available resources, for example by poling devices at regular intervals to update the services and/or resources associated with each device.

When the user-centric application is to be run, the orchestration module 212 obtains application software comprising a plurality of service modules 214. Each of the service modules 214 provides a portion of the functionality of the user-centric application. Associated with each service module is an indication of the resources requested by the service module 214 to provide the service associated with that service module. The indication of resources requested by the application service module 214 may include a user interface service request indicating user interface services requested by the service module 214. For example, the associated resource request may indicate that a particular service module 214 is to receive “keystroke” events, provide data to a further identified service module, and use local persistent storage to execute. Based on the associated resource request indication and on the resources associated with each edge compute device 220a-c identified as being available, the orchestration module 212 selects an edge device to be used to execute each service module 214 of the application, for example by matching the processing and memory requested to availability on an edge compute node.

The orchestration module 212 takes into account any specific resource requests, for example an application service module 214b that requests persistent storage may be deployed to edge compute device 220b in order to take advantage of storage 216. Service modules can then be deployed to the edge compute devices 220a-c in accordance with the selection made by the orchestration module 212. Furthermore, the orchestration module 212 may be provided with an indication of a current processing load relating to software modules already executing on each edge compute device 220a-c. Selection of an edge device 220 to be used to execute each particular service module 214 may be based in part on the current processing load of the edge compute devices 220a-c to avoid overloading a particular edge compute device.

In order to realize the application functionality, the orchestration module 212 further facilitates configuration of data flows between the deployed service modules 214 and the IoT devices 202, 204. For example, if a resource request associated with a service module indicates that the service module should receive keystroke events, a data flow between an IoT keyboard device and the service module may be configured. According to some examples, the configuration of data flows may be facilitated by messaging service 116, which may be provided by the orchestration module 212.

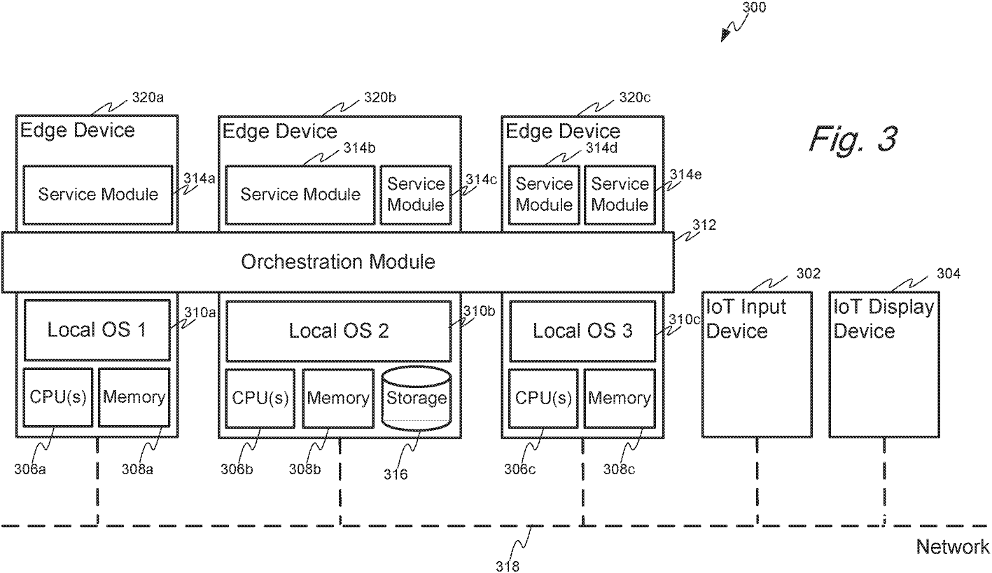

FIG. 3 illustrates an alternative schematic representation of a system 300 comprising edge devices and IoT devices in the system 100 of FIG. 1 according to an example of the disclosure. The system 300 illustrated in FIG. 3 is similar to that of FIG. 2, but relies on a distributed orchestration module 312, or layer, whereby the orchestration functionality is distributed across multiple edge compute devices 320a-c. Elements of FIG. 3 in common with those illustrated in FIG. 2 have similar reference numerals with the leading “2” replaced with a “3”.

The distributed orchestration module 312 may be provided with a consensus process to allow information relating to the available resources of each edge device to be exchanged and a common consensus reached on deployment of application service modules 314a-e to the available edge compute devices 320. In some examples, the distributed orchestration layer, or module, 312 may itself be comprised of service modules deployed to the edge compute devices 320.

As discussed above, the edge compute devices of FIGS. 2 and 3 may be provided as a heterogeneous set of devices having different capabilities. According to some examples, the edge compute devices may be provided by modules having different architectures and/or operating systems. To facilitate this arrangement, the orchestration module 312 may provide a common application programming interface for services used by the service modules. Furthermore, the application service modules 314a-e may be obtained in an easily redeployable form such as bytecode designed to be executed by a virtual machine provided on the edge compute devices or to be compiled on the selected edge device once the application service module has been deployed, for example using Just-in-Time compilation. Each edge compute device may be provided with a suitable execution environment to support the deployed application service modules 314a-e.

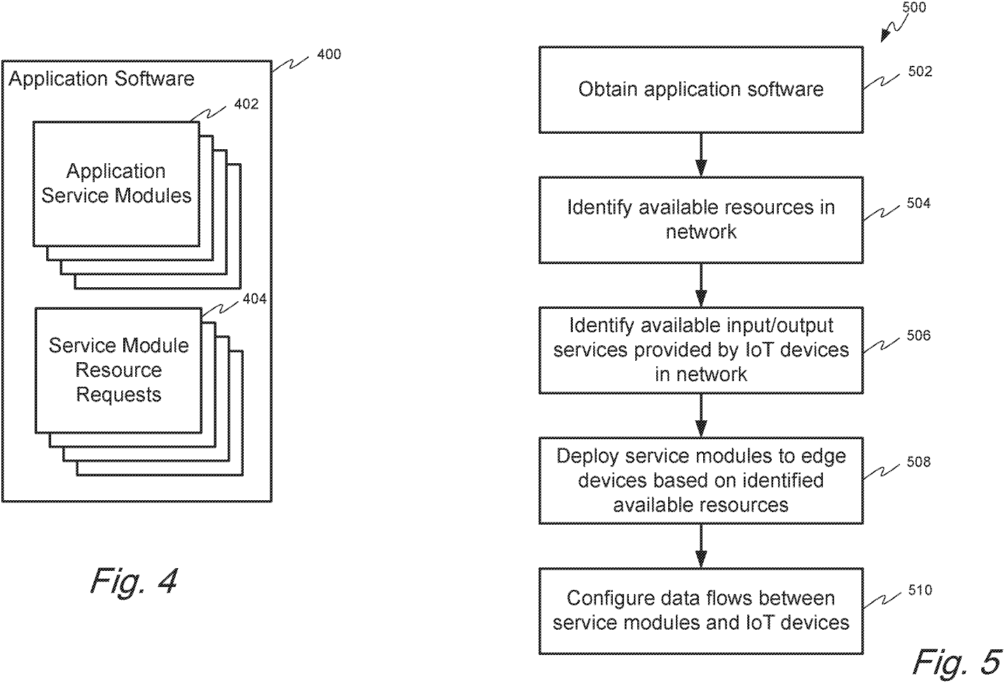

FIG. 4 illustrates an application 400 according to examples of the disclosure. The application 400 may provide functionality equivalent to a user-centric application executing on a personal computing device such as an application for email, word processing, photo viewing/editing, web-browsing, viewing digital TV, slide presenting/editing, video or audio conferencing, computer-aided design, PC gaming and viewing/editing social media, etc.

The application 400 comprises a plurality of application service modules 402 that each provide a portion of the functionality of the user-centric application. Each service module provides a particular function as a service with a defined Application Programming Interface (API) to allow other entities in the network to access the provided service.

For example, a first service module 402 may process input events, a second service module may provide database processing services, while a third service module may be directed to rendering a graphical user interface (GUI). Associated with each service module 402 is a service module resource request 404, which provides an indication of resources requested by the service module 402 to execute. For example, for the service module providing database processing services, the service module resource request may indicate that an amount of non-volatile storage local to the execution of the service module is requested, while the service module directed to rendering the GUI may have an associated request indicating that a GPU is desired, but not necessary.

The service module resource requests 404 can further provide an indication of requested human-machine interface services to be provided by IoT devices in the network to realize the user-centric application. For example, a resource request associated with the first application service module may indicate that keystroke and pointing events are requested as inputs to the module, while a resource request associated with the third application service module may indicate that an IoT device capable of consuming and rendering a display stream is requested.

Furthermore, the service module resource requests 404 may provide an indication of requested data flows between the application service modules 402 to realize the user-centric application functionality. For example, the third service module may request a continuous stream of processed pointing events to be passed to it at high bandwidth and low latency from the first service module in order to control the GUI.

FIG. 5 shows a method 500 of configuring a networked system comprising a plurality of edge compute devices and user interface IoT devices, such as the system of FIGS. 1, 2 or 3, to realize a user-centric application. According to the method of FIG. 5, the orchestration layer 312 obtains application software, such as application 400, comprising a plurality of application service modules 402, wherein each service module provides a portion of a functionality of the user-centric application. The orchestration layer 312 further obtains an indication of associated resource requests 404 associated with each application service module 402.

The orchestration layer 312 monitors the resources available in the network, and available processing resources associated with each of the edge compute devices in the network, to thereby identify 504 availabilities of processing, storage, hardware accelerator resources, etc. The orchestration layer 312 further identifies 506 input/output user interface services provided by IoT devices 302, 304 in the network. Based on the associated resource requests and the identified resources in the network, the orchestration layer 312 selects for each application service module 402 an appropriate edge compute device 320 to execute the service module and then deploys 508 the service modules to the selected edge devices. Data flows between the deployed service modules and the input/output services provided by the IoT devices 302, 304 are then configured 510, based on the identified services to match the input/output requests of the user-centric application 400.

Thus, a user centric-application that receives input from a user, provides application processing at edge compute devices of a local network, and then provides an output back to the user via an IoT output device can be realized without requiring use of a personal computing device, effectively emulating the experience of using a personal computing device while avoiding the costs involved in ownership.

As application processing may be performed locally in the edge compute nodes, or edge compute devices, of the network, the application functions can be provided with low latency, and do not rely on the presence of a reliable connection to a cloud service via the Internet.

The described approach allows an orchestration module to recruit different numbers of edge compute devices according to the requests of a particular application. This allows the processing power available to the user-centric application to be simply varied by varying the number or types of edge compute devices of an edge cluster used. This may allow certain nodes to be placed into low power mode when not used, reducing wasted energy.

Furthermore, the orchestration module 312 may be able to vary the number and types of IoT user interface devices used by a particular application according to availability or preferences of the user. For example, if a user desires an application that does not require a keyboard, the keyboard IoT device may be omitted from the system.

New IoT devices can be easily added to the network and may be automatically detected and configured by the orchestration layer/module 312. Similarly, resources and IoT devices may be configured in an ad-hoc manner based on variations in an application’s resource requests as individual application modules are deployed or executed.

In the case that multiple IoT devices exist offering the same type of user interface service, the orchestration module 312 may make intelligent choices based on user preferences or previous user activity. For example, when initiating a video conference application, a user may prefer video to be displayed on the Smart TV 106, but may prefer an application that displays a large amount of text to be presented on a tablet device screen for ease of reading.

Furthermore, development of new user-centric applications by cloud developers may be significantly simplified for the described architecture as new PC-like applications can be created from familiar microservice development methods, with easy reuse of application service modules, without requiring the developer to learn techniques for developing code dedicated for PC operating systems.

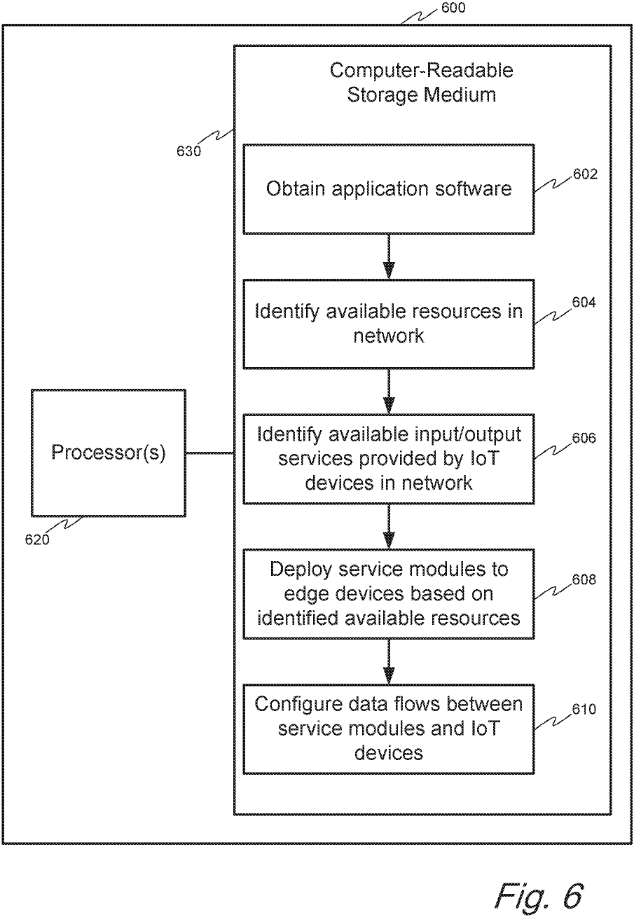

Certain methods and systems as described herein may be implemented by a processor that processes program code that is retrieved from a non-transitory storage medium. FIG. 6 shows an example of a device 600 comprising a computer-readable storage medium 630 coupled to at least one processor 620. The computer-readable medium 630 can be any medium that can contain, store, or maintain programs and/or data for use by or in connection with an instruction execution system or other system for giving effect to instructions. Computer-readable medium can comprise any one of many physical media such as, for example, electronic, magnetic, optical, electromagnetic, or semiconductor media. More specific examples of suitable machine-readable media include, but are not limited to, a hard drive, a random-access memory (RAM), a read-only memory (ROM), an erasable programmable read-only memory, or a portable storage such as, for example, a USB drive or disk.

In FIG. 6, the computer-readable storage medium 630 comprises program code to perform a method or implement a device as described herein. For example, the program code when executed may implement a method corresponding to the example shown in FIG. 5, that is: obtain 602 application software as an application comprising a plurality of application service modules; identify 604 available processing resources in the network; identify 606 available input/output user interface services provided by IoT devices in the network; deploy 608 the service modules to edge devices in the network based on the identified available resources; and configure 610 data flows between the deployed service modules and IoT devices to realize the user-centric application.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings, may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants that fall within the scope of the claims.

### EXAMPLES

According to example 1 there is provided a method of providing a user-centric application comprising a plurality of service modules, the method comprising identifying available resources associated with each of a plurality of edge devices in the local network, identifying a first device of the local network, the first device offering a user input service, identifying a second device of the local network, the second device to receive an output event and present the output event for consumption by the user, for each service module, each service module to provide a portion of a functionality of the user-centric application and having an associated resource request, deploying the service module to an edge device of the plurality of edge devices based on the associated resource request and the identified available resources, and configuring data flows between the deployed service modules, the first device, and the second device to realize the user-centric application.

Example 2, there is provided the method of example 1, wherein the second device comprises a display offering a display service, and wherein said configuring data flows further comprises configuring one of the deployed service modules to provide a display output event to the display.

Example 3, there is provided the method of example 1 or 2, further comprising the obtaining the plurality of service modules from a cloud computing platform.

Example 4, there is provided the method of any of examples 1 to 3, wherein the user-centric application comprises one or more of an email application, word processing application, image or photo viewing/editing application, audio or video editing/playback application, web-browsing application, viewing digital TV application, slide presenting/editing application, video or audio conferencing application, computer-aided design application, shopping/commerce application, PC gaming application and a viewing/editing social media application.

Example 5, there is provided the method of example 3, wherein said obtaining the plurality of service modules further comprises obtaining the plurality of service modules in response to a request to provide the user-centric application received via a device of the local network.

Example 6, there is provided the method of any of examples 1 to 5, wherein the first device comprises a first IoT device, the first IoT device comprising one of: a keyboard, a mouse, a microphone, trackpad, and a camera device.

Example 7, there is provided the method of any of examples 1 to 6, further comprising determining that insufficient resources are available within the local network to deploy a first service module of the plurality of service modules, requesting a cloud computing platform to provide a service corresponding to the portion of the functionality of the user-centric application provided by the first service module, and configuring data flows between the deployed service modules, the first device, the second device, and the cloud computing platform to realize the user-centric application.

Example 8, there is provided the method of any of examples 1 to 7, wherein the resource request associated with a first service module of the plurality of service modules further comprises an associated user interface service request, and wherein configuring data flows between the deployed service modules and the first device comprises configuring data flows for the first deployed service module based on the associated user interface service request and on the user input service offered by the first device.

According to example 9, there is provided a computing device comprising a network interface for communicating with a plurality of edge nodes in a local network, an orchestration module coupled to the network interface, the orchestration module to identify available resources associated with each of the plurality of edge nodes in the local network, identify an device in the local network, the device to receive an output event and present the output event for consumption by the user, select edge nodes of the plurality of edge nodes to execute a user-centric application, wherein the user-centric application comprises a plurality of service modules, each service module having an associated resource request and providing a portion of a functionality of the user-centric application, and wherein selection of edge nodes to execute the user-centric application further comprises, for each service module of the user-centric application, select an edge node of the plurality of edge nodes to execute the service module based on the identified available resources and the resource request of the service module, deploy the service modules to the selected edge nodes, and configure data flows between the deployed service modules and the device, to realize the user-centric application.

Example 10, there is provided the computing device of example 9, further comprising a network gateway to couple the computing device to the external network, wherein the orchestration module is further to obtain the plurality of service modules from a cloud computing platform via the network gateway.

Example 11, there is provided the computing device of examples 9 or 10, further comprising a network gateway to couple the computing device to an external network, wherein the orchestration module is further to determine that insufficient resources are available within the local network to deploy a first service module of the plurality of service modules, request, via the network gateway, a cloud computing platform to provide a service corresponding to the portion of the functionality of the user-centric application provided by the first service module, and configure data flows between the deployed service modules, the device, and the cloud computing platform to realize the user-centric application.

According to example 12, there is provided a system of heterogeneous devices in a local network, the system comprising the computing device of any of examples 9 to 11, a plurality of heterogeneous edge nodes, a first device to provide a user input service, a second device to receive an output event and present the output event for consumption by the user, and wherein the orchestration module is further to identify the output event to be received by the second device, and configure data flows between the edge compute nodes, the first device, and the second device to implement the user-centric application.

Example 13, there is provided the system of example 12, further comprising a network gateway to connect to the Internet, the orchestration module further to obtain the service modules from a cloud computing service via the network gateway and to request the cloud computing service to provide a service corresponding to a portion of the functionality of the user-centric application.

According to example 14, there is provided a non-transitory machine readable medium comprising instructions that, when executed on a computing device of a local network, cause the computing device to monitor available resources associated with each of a plurality of edge devices in the local network, monitor input/output user interface services offered by a plurality of devices in the local network, deploy a user-centric application to edge devices of the plurality of edge devices, wherein the user-centric application comprises a plurality of service modules, each service module having an associated resource request and providing a portion of a functionality of the user-centric application, and wherein deployment of edge devices to execute the user-centric application further comprises, for each service module, deploy the service module to an edge device of the plurality of edge devices based on the associated resource request and the identified available resources, and configure data flows between the deployed service modules and the input/output user interface services to realize the user-centric application.

Example 15, there is provided the non-transitory machine readable medium of example 14, wherein the instructions are further to, when executed on the computing device, cause the computing device to identify a first device of the local network, the first device to provide a user input service, identify a second device of the local network, the second device to receive an output event and present the output event for consumption by the user, and wherein configuring data flows between the deployed service modules and the input/output user interface services further comprises configuring data flows from the first device to at least one service module of the deployed service modules, and from at least one service module of the deployed service modules to the second device to realize the user-centric application.

1. A method of providing a user-centric application comprising a plurality of service modules, the method comprising:
identifying available resources associated with each of a plurality of edge devices in the local network;
identifying a first device of the local network, the first device offering a user input service;
identifying a second device of the local network, the second device to receive an output event and present the output event for consumption by the user;
for each service module, each service module to provide a portion of a functionality of the user-centric application and having an associated resource request, deploying the service module to an edge device of the plurality of edge devices based on the associated resource request and the identified available resources; and
configuring data flows between the deployed service modules, the first device, and the second device to realize the user-centric application.

2. The method of claim 1, wherein the second device comprises a display offering a display service, and wherein said configuring data flows further comprises configuring one of the deployed service modules to provide a display output event to the display.

3. The method of claim 1, further comprising the obtaining the plurality of service modules from a cloud computing platform.

4. The method of claim 1, wherein the user-centric application comprises one or more of an email application, word processing application, image or photo viewing/editing application, audio or video editing/playback application, web-browsing application, viewing digital TV application, slide presenting/editing application, video or audio conferencing application, computer-aided design application, shopping/commerce application, PC gaming application and a viewing/editing social media application.

5. The method of claim 3, wherein said obtaining the plurality of service modules further comprises obtaining the plurality of service modules in response to a request to provide the user-centric application received via a device of the local network.

6. The method of claim 1, wherein the first device comprises a first IoT device, the first IoT device comprising one of: a keyboard, a mouse, a microphone, trackpad, and a camera device.

7. The method of claim 1, further comprising:
determining that insufficient resources are available within the local network to deploy a first service module of the plurality of service modules;
requesting a cloud computing platform to provide a service corresponding to the portion of the functionality of the user-centric application provided by the first service module; and
configuring data flows between the deployed service modules, the first device, the second device, and the cloud computing platform to realize the user-centric application.

8. The method of claim 1, wherein the resource request associated with a first service module of the plurality of service modules further comprises an associated user interface service request, and wherein configuring data flows between the deployed service modules and the first device comprises configuring data flows for the first deployed service module based on the associated user interface service request and on the user input service offered by the first device.

9. A computing device comprising:
a network interface for communicating with a plurality of edge nodes in a local network;
an orchestration module coupled to the network interface, the orchestration module to:
identify available resources associated with each of the plurality of edge nodes in the local network;
identify a device in the local network, the device to receive an output event and present the output event for consumption by the user;
select edge nodes of the plurality of edge nodes to execute a user-centric application, wherein the user-centric application comprises a plurality of service modules, each service module having an associated resource request and providing a portion of a functionality of the user-centric application; and
wherein selection of edge nodes to execute the user-centric application further comprises, for each service module of the user-centric application, select an edge node of the plurality of edge nodes to execute the service module based on the identified available resources and the resource request of the service module;
deploy the service modules to the selected edge nodes; and
configure data flows between the deployed service modules and the device, to realize the user-centric application.

10. The computing device of claim 9, further comprising a network gateway to couple the computing device to the external network, wherein the orchestration module is further to obtain the plurality of service modules from a cloud computing platform via the network gateway.

11. The computing device of claim 9, further comprising a network gateway to couple the computing device to an external network, wherein the orchestration module is further to:
determine that insufficient resources are available within the local network to deploy a first service module of the plurality of service modules;
request, via the network gateway, a cloud computing platform to provide a service corresponding to the portion of the functionality of the user-centric application provided by the first service module; and
configure data flows between the deployed service modules, the device, and the cloud computing platform to realize the user-centric application.

12. A system of heterogeneous devices in a local network, the system comprising:
the computing device of claim 9;
a plurality of heterogeneous edge nodes;
a first device to provide a user input service;
a second device to receive an output event and present the output event for consumption by the user; and
wherein the orchestration module is further to:
identify the output event to be received by the second device; and
configure data flows between the edge compute nodes, the first device, and the second device to implement the user-centric application.

13. The system of claim 12, further comprising a network gateway to connect to the Internet, the orchestration module further to obtain the service modules from a cloud computing service via the network gateway and to request the cloud computing service to provide a service corresponding to a portion of the functionality of the user-centric application.

14. A non-transitory machine readable medium comprising instructions that, when executed on a computing device of a local network, cause the computing device to:
monitor available resources associated with each of a plurality of edge devices in the local network;
monitor input/output user interface services offered by a plurality of devices in the local network;
deploy a user-centric application to edge devices of the plurality of edge devices, wherein the user-centric application comprises a plurality of service modules, each service module having an associated resource request and providing a portion of a functionality of the user-centric application; and
wherein deployment of edge devices to execute the user-centric application further comprises, for each service module, deploy the service module to an edge device of the plurality of edge devices based on the associated resource request and the identified available resources; and
configure data flows between the deployed service modules and the input/output user interface services to realize the user-centric application.

15. The non-transitory machine readable medium of claim 14, wherein the instructions are further to, when executed on the computing device, cause the computing device to:
identify a first device of the local network, the first device to provide a user input service;
identify a second device of the local network, the second device to receive an output event and present the output event for consumption by the user; and
wherein configuring data flows between the deployed service modules and the input/output user interface services further comprises configuring data flows from the first device to at least one service module of the deployed service modules, and from at least one service module of the deployed service modules to the second device to realize the user-centric application.
